(19) United States
(12) Patent Application Publication
(10) Pub. No.: US 2022/0297160 A1
(43) Pub. Date: Sep. 22, 2022

(54) COMPACT SORTER

(71) Applicant: Laitram, L.L.C., Harahan, LA (US)

(72) Inventors: Mark Costanzo, New Orleans, LA (US); Christopher J. Gatz, Noblesville, IN (US); Destin Jacob Bailey, Marrero, LA (US); Nischal Nath Pant, New Orleans, LA (US); Matthew L. Fourney, Laurel, MD (US)

(21) Appl. No.: 17/608,916

(22) PCT Filed: Apr. 28, 2020
(86) PCT No.: PCT/US2020/030192

§ 371 Date: Nov. 4, 2021

Related U.S. Application Data
(60) Provisional application No. 62/852,785, filed on May 24, 2019.

(51) Int. Cl. B07C 3/08; B65G 47/46; B65G 11/12

(52) U.S. Cl. CPC B07C 3/08; B65G 47/46; B65G 11/123; B65G 2201/0285; B65G 2203/041

(57) ABSTRACT

A sorting conveyor system comprising a main sorting conveyor sorting packages directly into destination receptacles or first onto discharge sorting conveyors and further onto other destination receptacles. Multi-destination discharge chutes service two or more destination receptacles. Package detectors detect packages delivered to the destination receptacles to help identify packages sorted to the wrong destination receptacles.

### BACKGROUND

The invention relates generally to power-driven conveyors and more particularly to sorting conveyors and multi-destination chute discharges.

In various industries such as in package- and parcel-handling, sorting conveyors are used to sort packages into destination receptacles, such as bins, bags, hampers, or totes. Often the packages are discharged from the main sorting conveyor onto chutes leading to the specified destination receptacle. If many sorting destinations are required, the main sorting conveyor can be long and occupy significant floor space.

### SUMMARY

A multi-destination discharge chute embodying features of the invention comprises a chute on which packages ride from an upper end to a lower end and destination receptacles below the lower end of the chute. Each package is assigned to be received in a selected destination receptacle. A receptacle mover moves the destination receptacles to position the selected destination receptacle into position to receive packages assigned to it.

A sorting conveyor system embodying features of the invention comprises a main sorting conveyor transporting packages in a main conveying direction and a controller controlling the main sorting conveyor to selectively sort the packages off one or both sides of the main sorting conveyor at sorting positions along its length. One or more discharge sorting conveyors disposed at one or more of the other sorting positions receive packages sorted off the main sorting conveyor. The controller controls the one or more discharge sorting conveyors to selectively sort the packages off one or both sides of the discharge sorting conveyors at discharge sorting positions. Destination receptacles disposed at the discharge sorting positions receive packages sorted off the one or more discharge sorting conveyors.

### BRIEF DESCRIPTION OF THE DRAWINGS

FIG. 1 is a top plan view of one version of a sorting system embodying features of the invention.

FIG. 2 is an isometric view of a flip-gate chute discharge usable in a sorting conveyor as in FIG. 1.

FIGS. 3A and 3B are side elevation views of the flip-gate chute discharge of FIG. 2 shown in first and second discharge positions.

FIG. 4 is a side elevation view of another version of flip-gate discharge in a sorting system as in FIG. 1.

FIGS. 5A and 5B are side elevation views of two separate destination receptacles that move back and forth on a rail system at the end of a chute for a sorting system as in FIG. 1 shown in first and second discharge positions.

FIG. 6 is a side elevation view of two separate destination receptacles on a bidirectional conveyor belt at the end of a chute for a sorting system as in FIG. 1.

FIGS. 7A and 7B are isometric views of another version of a chute discharge for a sorter as in FIG. 1 shown in two diverting positions and using a coiled roller belt to divert packages.

FIG. 8 is an isometric view of a discharge for a sorter as in FIG. 1 driving wheeled receptacles with a rack and pinion.

FIGS. 9A and 9B are side elevation views of the discharge of FIG. 8 in its two discharge positions.

FIGS. 10A and 10B are side elevation views as in FIGS. 9A and 9B of pulley-driven wheeled bins.

FIG. 11 is an isometric view of a belt-driven discharge as in FIG. 6 for a series of destination bags.

FIGS. 12A and 12B are side elevation views of the discharge of FIG. 11 showing the bags in two different discharge positions.

FIG. 13 is an isometric view of the discharge of FIG. 11 outfitted with a fixed package backstop.

FIGS. 14A and 14B are isometric views of a discharge as in FIG. 11 with pop-up package backstops shown down and up.

FIG. 15 is a side elevation view of FIG. 14B.

FIG. 16 is an isometric view of robot-driven receptacles usable in the sorter of FIG. 1.

FIG. 17 is a side elevation view of a photo-eye package detector for a sorter as in FIG. 1.

FIG. 18 is an isometric view of another version of a package detector for the sorter of FIG. 1 using a camera to detect packages.

FIG. 19 is a block diagram of a control system for the sorting conveyor of FIG. 1.

FIG. 20 is a flowchart of the program steps executed by the control system of FIG. 19 to detect missorts with the package detectors of FIG. 17 or FIG. 18.

### DETAILED DESCRIPTION

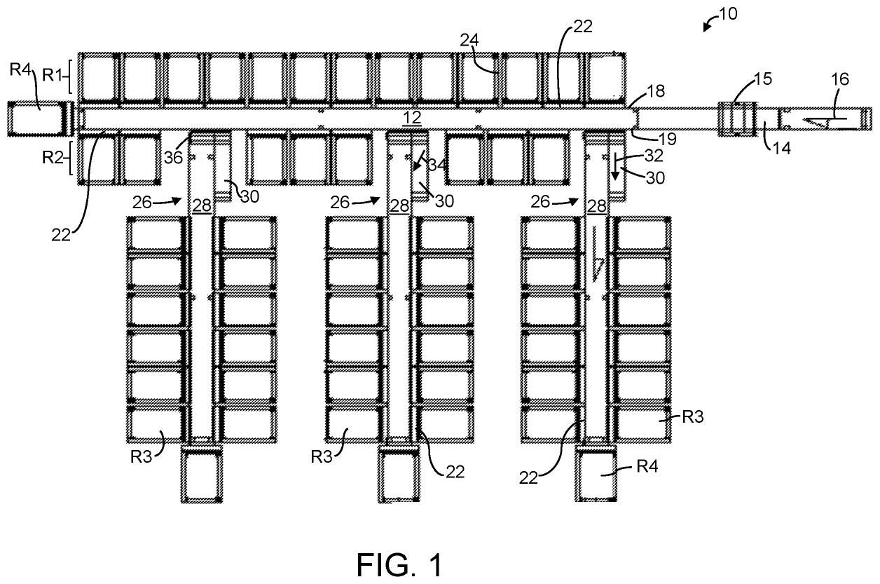

A compact sorting system embodying features of the invention is shown in FIG. 1. The sorting system 10 includes a main sorting conveyor 12 receiving packages from an infeed conveyor 14. Both conveyors 12, 14 transport packages in a main conveying direction 16. A scanner 15 scans the packages for addresses or other indicia indicating their destinations. The infeed conveyor 14 can be a roller conveyor or a belt conveyor, for example. The main sorting conveyor 12 can be a roller conveyor with swivel sorters, a shoe sorter, or a belt conveyor, such as an INTRALOX® Series 7000 conveyor belt with roller actuation, an INTRALOX® Series 7050 conveyor belt with dual-stacked belt rollers, an INTRALOX® Series 4550 Bidirectional Dual Angled Roller belt, or, for unilateral sorting only, an INTRALOX® Series 4500 or 4550 Dual Angled Roller belt. Such belt conveyors are described in U.S. Pat. No. 9,079,717, “Conveyor System for Diverting Objects,” Mark Costanzo et al., Jul. 14, 2015; in U.S. Pat. No. 10,059,522, “Divert Chutes in Sorting-Conveyor Systems,” Stephen G. Wargo et al., Aug. 28, 2018; in U.S. Pat. No. 8,225,922, “Transverse Drive-Roller Belt and Conveyor,” Matthew L. Fourney, Jul. 24, 2012; in U.S Pat. No. 9,108,801, “Conveyor Belt Having Bidirectional Stacked Rollers,” Mark Costanzo et al., Aug. 18, 2015; and in U.S. Pat. No. 8,678,180, “Modular Conveyor Belt with Extended Raised Ribs,” Angela Longo Marshall et al., Mar. 25, 2014. The disclosures of those patents are incorporated into this application by reference.

The exemplary belt conveyor 12 used as the main conveyor in describing the sorting system is characterized by an array of rollers that are selectively rotatable to one side of the belt or the other. The rollers are mounted on axles parallel to the conveying direction 16. (In other roller belts that could be used as the main conveyor, the rollers could be arranged to rotate on axles oblique to the conveying direction, such as forming a 30°, 45°, or 60° angle with the conveying direction.) Independently controllable roller actuators under the belt on the carryway have rollers themselves that contact the bottoms of the belt rollers as they pass by. The axes of rotation of the actuating rollers are pivotable from a first oblique angle relative to the main conveying direction 16 to a second oblique angle that is a mirror image of the first about the main conveying direction. When the actuating rollers are at the first angle, they cause the belt rollers to rotate toward a first side 18 of the belt. When at the second angle, the actuating rollers cause the belt rollers to rotate toward an opposite second side 19 of the belt. The roller actuators are positioned under the belt at sorting positions along the length of the main conveyor 12. The packages destined for destinations at the first side 18 of the main conveyor 12 are sorted off by the actuated belt rollers into receptacles R1, such as bins, bags, hampers, or totes, at the sorting positions. The packages can be discharged directly into the receptacles or via chutes 22, for example. Barriers 24 between discharge destinations prevent packages from overshooting their assigned destinations. Packages destined for discharge off the second side 19 are sorted off onto receptacles R2 directly or via chutes 22 or onto merge conveyors 26 at the sorting positions.

The merge conveyors 26 comprise a discharge sorting conveyor 28, like the main conveyor 12, and a shorter diverting conveyor 30. The diverting conveyor 30 may be a roller conveyor or an activated roller-belt conveyor using, for example, an INTRALOX® Series 400 activated roller belt with rollers arranged to rotate on axles oblique to the direction of belt travel 32 as indicated by arrow 34 and activated by roller or flat bearing surfaces below. The activated belt rollers direct packages discharged from the main sorting conveyor 12 onto the discharge sorting conveyor 28. The diverting conveyor 30 abuts the discharge sorting conveyor 28 and widens the landing zone for packages to be sorted onto the discharge sorting conveyor. Packages sorted onto the discharge sorting conveyors 28 are then sorted into their assigned destination discharge receptacles R3. Receptacles R4 at the ends of the sorting conveyors 12, 28 receive packages not sorted to any of the other receptacles R1-R3. The packages are sorted into the receptacles directly or via chutes 22. Merge conveyors could be positioned at the first side 18 as well.

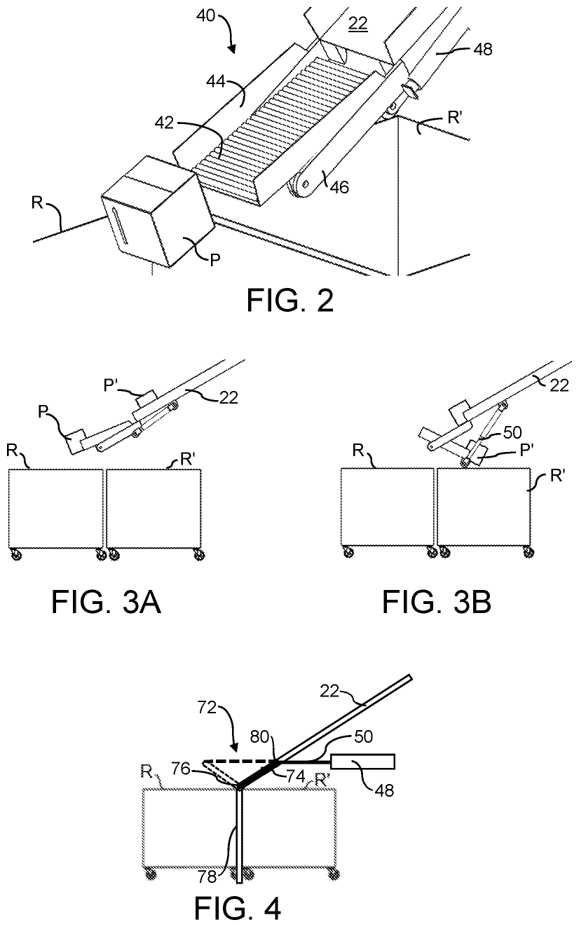

The amount of floor space taken up by the compact sorting conveyor of FIG. 1 is reduced by providing a multi-destination discharge chute system 40 in FIG. 2 for discharging packages into selected destination receptacles. The ends of the discharge chutes 22 lead to destination receptacles R, R′, such as wheeled bins. The discharge chute system 40 in FIGS. 2, 3A, and 3B includes a flip gate comprising a roller curtain 42 mounted in a frame 44. The roller curtain 42 can be constructed of a series of individual parallel rollers as shown in FIG. 2 or can be constructed of a section of a roller conveyor belt, such as an INTRALOX® Series 1000 insert roller belt or Series 400 0° inline roller belt. Arms 46 are fastened at proximal ends to the end of the chute 22. The frame 44 is pivotably attached to the distal ends of the arms 46. A pair of pneumatic or hydraulic cylinders or linear actuators 48 pivotably attached to the bottom side of the chute 22 and to the bottom of the frame 44 on opposite sides pivot the roller curtain 42 from a first position, shown in FIGS. 2 and 3A, in which a package P drops into a first destination receptacle R, to a second position in which a package P′ drops into a second destination receptacle R′, as shown in FIG. 3B. A package P destined for the first destination receptacle R rides down the roller curtain 42 off its lower end farther from the chute 22 and into the first receptacle. When a package P′ is destined for the second destination receptacle R′, the cylinder or actuator extends its rod 50 to pivot the roller curtain 42 into the second position, in which the end of the roller curtain closer to the chute 22 is angled downward from its opposite end and the intercepted package P′ rides down the roller curtain. In this way a single chute 22 can be used to supply two destination receptacles R, R′. And because the second receptacle R′ is positioned beneath the chute, floor space is conserved.

Another multi-destination chute system with flip-gate discharge is shown in FIG. 4. The flip gate 72 is made of a section of roller belt 74, such as the INTRALOX® Series 1000 insert roller belt whose rollers are mounted on hinge rods and extend through the thickness of the belt to protrude from both sides. The belt section is stiffened into a planar curtain hingedly connected along a lower end 76 to a support 78. The rods 50 of cylinders or other linear actuators 48 are pivotally attached to opposite sides of the roller-belt curtain 74 at its upper end 80. The actuator's rods 50, when retracted, position the curtain 74 in a first position aligned with the chute 22 to direct packages into the first receptacle R. When the rod 50 is extended, as shown in dashed lines, the curtain 74 is pivoted away from the chute into a second position separated from the chute but positioned to intercept packages on the opposite side of the belt and redirect them to the second receptacle R′. Because the rollers protrude from both sides of the curtain, both sides provide a low-friction slide to the packages. Because the flip gates of FIGS. 2 and 4 are tilted off horizontal in both positions, they could be made with slide surfaces along which packages slide rather than rollers along which packages roll.

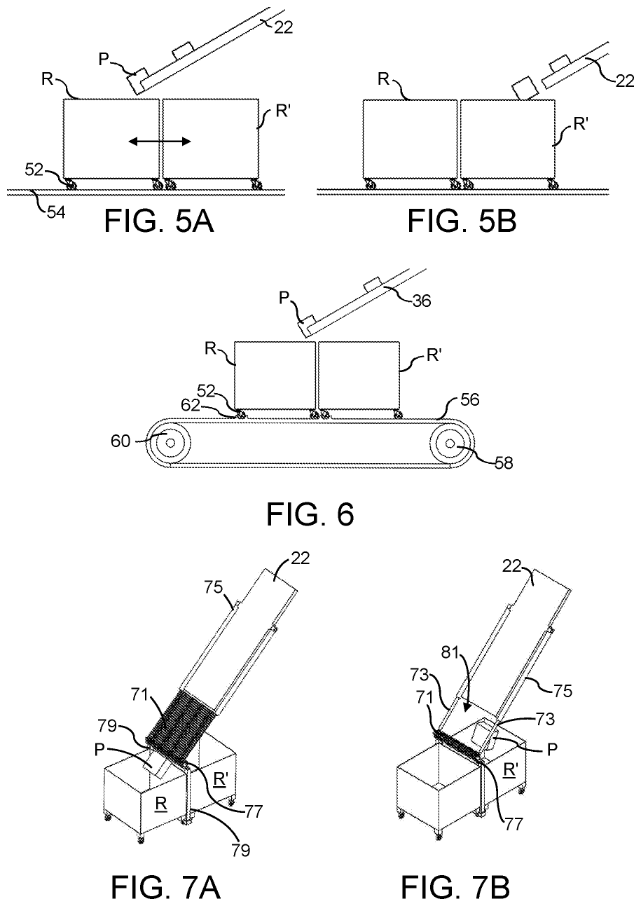

A multi-destination chute system having a receptacle mover moving destination receptacles to position a selected assigned destination receptacle into position to receive packages assigned to it is shown in FIGS. 5A and 5B. In this version the two receptacles R, R′ are mounted side by side with their wheels 52 mounted on rails 54 in a rail system. The receptacle mover is motorized so that the pair of receptacles R, R′ can be shuttled from a first position (FIG. 5A), in which the first receptacle R is positioned to receive packages P from the chute 22, to a second position (FIG. 5B), in which the second receptacle R′ is positioned to receive packages from the chute.

Yet another version of a multi-destination chute system is shown in FIG. 6. In this version of a receptacle mover, the two destination receptacles R, R′ are mounted atop a bidirectional conveyor belt 56 trained around drive and idle pulleys 58, 60. Chocks 62 on the belt surface stabilize the receptacles' wheels 52 to prevent the receptacles from rolling in response to the belt's back-and-forth motion. The drive pulley 58 moves the belt to selectively position either the first receptacle R (as in FIG. 6) or the second receptacle R′ in position to receive packages P from the chute 22.

FIGS. 7A and 7B illustrate a multi-destination chute system with a discharge that uses an inline roller belt 71 as in FIG. 4 at the end of the chute 22. But, unlike the stiffened roller belt 74 of FIG. 4, the roller belt 71 is able to articulate at its hinge joints. The roller belt 71 is attached at the corners of its upper end to arms 73 of linear actuators 75 on the sides of the chute 22. The lower end of the roller belt 71 is attached to a motorized roller or spindle 77. The spindle 77 is supported by legs 79 at each end. The legs 79 are positioned to support the spindle 77 above the space between first and second destination receptacles R, R′. In FIG. 7A the arms of the actuators 75 are retracted, and the upper end of the roller belt 71 is positioned at the lower end of the chute 22. With the roller belt 71 in that closed-gap position, packages P ride down the rollers and drop into the first destination receptacle R. The motorized spindle 77 is actuated in FIG. 7B to wrap, or coil, the roller belt 71 about the spindle. The coiled belt 71 forms a gap 81 between itself and the lower end of the chute 22. The gap 81 is positioned above the second destination receptacle R′. A package P sliding down the chute 22 drops through the gap 81 and into the second receptacle R′ when the roller belt is coiled around the spindle 77. The linear actuators 75 maintain tension in the belt 71 as it is coiled about the spindle 77 and retract their arms 73 when the motorized spindle is deactuated.

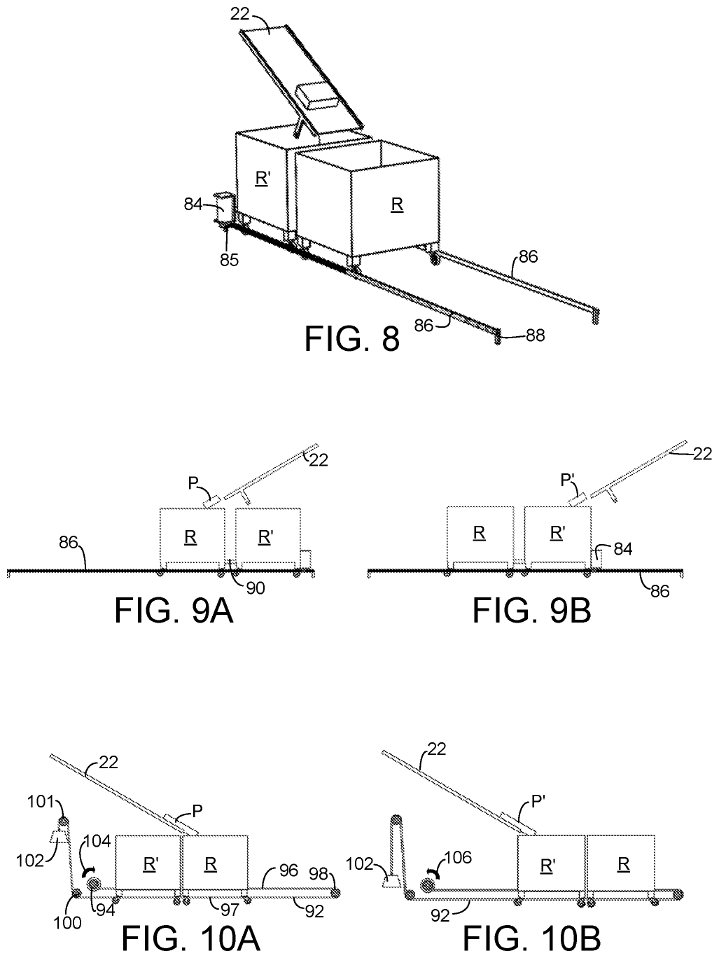

Instead of a rail system as in FIGS. 5A and 5B and a bidirectional conveyor belt as in FIG. 6, a multi-destination chute system with a receptacle mover translates the two destination receptacles R, R′ relative to the chute 22 with a rack-and-pinion system driven by motors 84 mounted at each end of the second receptacle R′ on one or both sides, as shown in FIGS. 8, 9A, and 9B. Pinion gears 85 coupled to each of the motors 84, are engaged with a rack gear 86 on each side of the receptacles R, R′. The rack is supported by legs 88 at each end. The two receptacles R, R′ are joined by a connection 90 so that they roll together as a unit between the two racks 86. FIG. 9A shows the receptacles R, R′ in a first position in which the first receptacle R receives a package P dropping from the end of the chute 22. In FIG. 9B the motor 84 has moved the receptacles R, R′ along the racks 86 to a second position, in which a package P′ dropping off the lower end of the chute lands in the second receptacle R′.

A similar version of a multi-destination chute system with a receptacle mover is shown in FIGS. 10A and 10B in first and second positions. Instead of being driven by a rack-and-pinion system, the receptacles R, R′ are driven together by a pulley system. A cable 92 wrapped around a motorized drum 94 extends along a first run 96 and around an idle pulley 98 and along a parallel second run 97 and around lower and upper idle pulleys 100, 101. A counterweight 102 at the end of the cable 92 opposite the motorized drum 94 is suspended from the upper pulley 101. The counterweight 102 tensions the cable 92. The two receptacles R, R′ are attached to the cable 92. When the motorized drum 94 rotates in the direction of the arrow 104 as in FIG. 10A, it winds in the cable 92, lifts the counterweight 102, and moves the receptacles R, R′ to the first position, in which a package P drops from the lower end of the chute 22 into the first destination receptacle R. The motorized drum rotates in the opposite direction as indicated by the arrow 106 in FIG. 10B to pay out the cable 92 under tension from the counterweight 102 and move the receptacles R, R′ into the second position to divert a package P′ into the second destination receptacle R′.

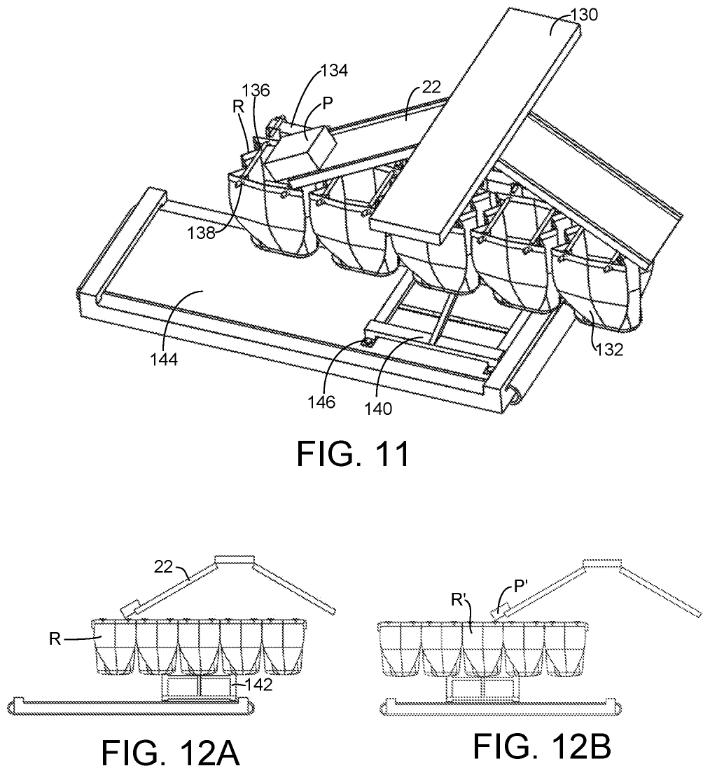

Another version of a multi-destination chute system with a receptacle mover using a conveyor belt to change the positions of receptacles relative to a chute is shown in FIGS. 11-15. A main sorting conveyor 130 selectively sorts packages P onto chutes 22 on opposite sides of the conveyor. Packages P drop off the chute 22 into a destination receptacle R, such as an open bag 132 below the lower end of the chute. The bags 132 are attached to a side frame 134 by rods 136. The rods 136, which are retained at one end by the frame 134, extend through eyelets 138 in the top rims of the bags 132. The bags 132 are suspended from the cantilevered rods 136, which are spaced far enough apart to keep the bags 132 open. The side frame 134 is attached to a base 140 by side members 142 (FIG. 12A). The base 140 is attached to a conveyor belt 144 by bolts 146 through the base's four corners. The bolts 146 are screwed into threaded inserts in the belt 144. A motor (not shown) drives the belt 144 and the bags 132 back and forth to align the selected destination bag with the lower end of the chute 22 to receive a package P. As shown in FIG. 12A, the package P is destined for the bag receptacle R. In FIG. 12B the bags are shown translated into position to deliver a package P′ to the bag receptacle R′.

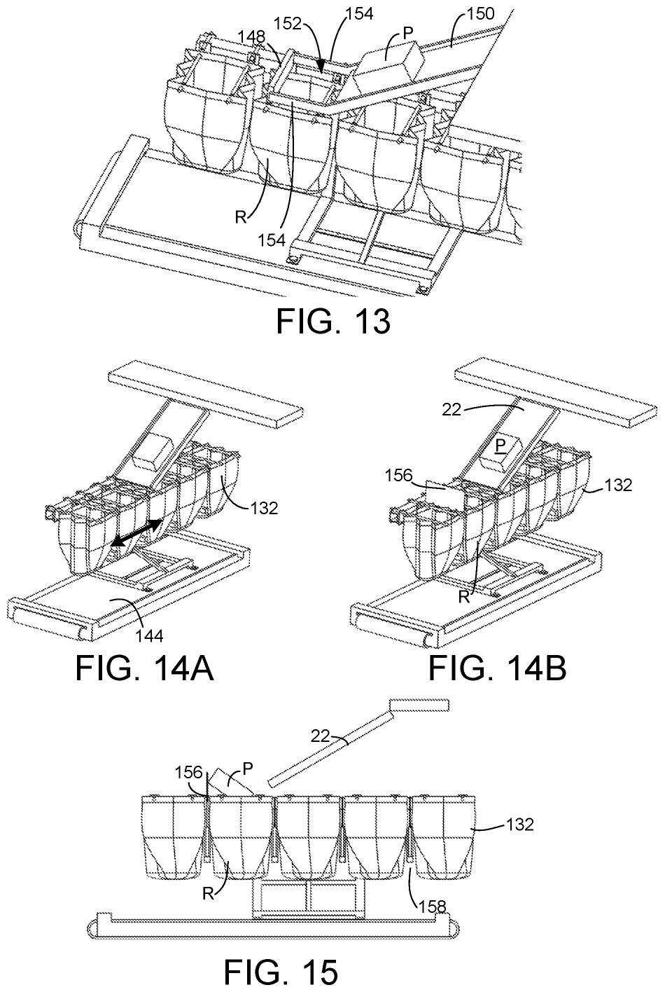

To prevent fast-moving packages P from overshooting the destination receptacle R, a fixed package backstop 148, as shown in FIG. 13, is appended to the lower end of a chute 150 across a gap 152 by a pair of arms 154. A fast-moving package that hits the backstop 148 is deflected through the gap 152 and into the selected receptacle R. The fixed backstop 148 is shown as a flat plate extending across the width of the receptacles R.

FIGS. 14A, 14B, and 15 show pop-up backstops 156 between adjacent bags 132. Actuators, such as linear actuators 158, raise and lower the backstops 156. As shown in FIG. 14A, all the backstops are lowered below the level of the tops of the bags 132 while the conveyor belt 144 is moving the bags 132 to a different position. When the selected destination bag receptacle R is stopped in position to receive a package P, as in FIG. 14B and FIG. 15, the actuator 158 raises the backstop 156 at the side of the receptacle R farther from the chute 22 above the level of the tops of the receptacles. In that way a fast-moving package P is prevented from overshooting and is deflected by the backstop 156 into the correct receptacle R.

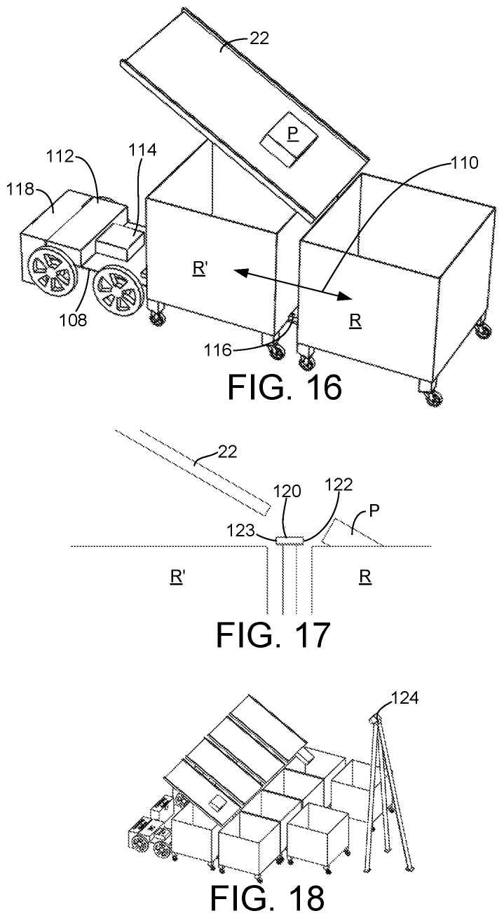

Receptacles R, R′ are shown translated by a wheeled robotic vehicle 108 in the multi-destination chute system of FIG. 16. The receptacle-moving robotic vehicle 108 pushes and pulls the coupled receptacles R, R′ as indicated by the arrow 110 between a first position, shown in FIG. 16, in which a package P falls off the end of the chute 22 into the first receptacle R, and a second position, in which the second receptacle R′ is moved into position below the lower end of the chute. The robotic vehicle 108 includes a rechargeable battery 112 powering a motor controller and a receiver housed in a control housing 114. The receiver receives commands from a controller controlling the operation of the sorting conveyor to translate the receptacles R, R′ to the correct position for each sorted package. The receptacles R, R′ are joined by a connection 116. A battery charging station 118 is provided to recharge the vehicle's battery 112 when the vehicle is at its innermost position or is offline.

It can happen that a package is mistakenly sorted to the wrong destination receptacle. FIG. 17 shows a bidirectional package detector 120 mounted between two adjacent receptacles R, R′ to detect such missorts. The package detector 120 has two arrays of photo eyes 122, 123, each detecting packages P dropping from the chute 22 and entering one of the destination receptacles R, R′. The detector 120 reports the delivery of a package to the sorting conveyor's controller. In FIG. 17 the detector reports the delivery of a package P to the receptacle R as detected by the photo-eye array 122. Another version of a missort-detection system, shown in FIG. 18, uses a camera 124 and video imaging as a package detector to detect packages and report their delivery to the sorting conveyor's controller.

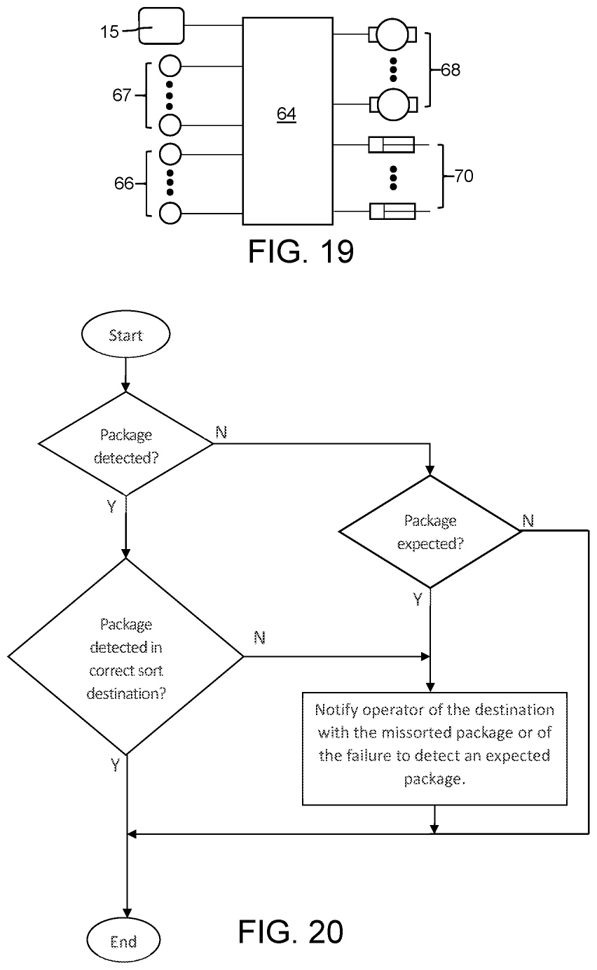

The sorting conveyor is controlled by a controller 64, such as a programmable logic controller or other programmable computer, as shown in FIG. 19. The controller, executing program steps in its program memory, receives data from the scanner 15 for each package. From that data, the controller assigns the destination receptacle for each package to sort it correctly. Position sensors 66 along the main sorting conveyor and the discharge sorting conveyors provide position information to the controller 64 that enable the controller to track each package. Package detectors 67 report the entry of packages into receptacles. The controller 64 controls motors 68 that drive the main and discharge sorting conveyors, motor-driven chute discharges, and other motor-driven belts and rollers in the sorting system. The controller 64 also controls linear actuators 70 or other mechanisms that control the chute discharges.

The sorting system's controller 64 executes program steps stored in program memory to handle missorted packages. The flowchart of FIG. 20 describes the operation of missort detection. The package detector, whether photo eyes or a camera or another sensor capable of sensing the entry of a package into a receptacle, continuously monitors the receptacles. If a package is detected entering a receptacle, the controller, which knows the states of the chute discharges from the position of the receptacles relative to the lower ends of the chutes, determines if the package has been sorted to its assigned destination receptacle. If so, it takes no action; if not, the controller notifies an operator through an indicator light, a message or indication on a display, an alarm, or other alert of a receptacle with a missorted package. If a package is not detected, but was expected, the controller notifies the operator that an expected package was not delivered.

Although the invention has been described with reference to a few versions, other versions are possible. For example, many versions of multi-destination discharge chutes were described as having only two destination receptacles. But it would be possible to extend some of the versions—for example, the versions shown in FIGS. 5, 6, 8, 10A, and 16—to more than two destination receptacles as for the system of FIGS. 11-15. As another example, the only destination receptacles used as examples are bags and wheeled bins. But totes, hampers, wheelless bins, or platforms, for example, could be used as alternative destination receptacles. So, as these few examples show, the scope of the invention is not meant to be limited to the details of the various exemplary versions.

What is claimed is:

1. A multi-destination discharge chute comprising:
a chute on which packages ride from an upper end to a lower end;
a plurality of destination receptacles below the lower end of the chute, wherein each package is assigned to be received in a selected one of the destination receptacles;
a receptacle mover moving the plurality of destination receptacles to position the selected one of the destination receptacles into position to receive packages assigned to it.

2. The multi-destination discharge chute of claim 1 comprising a backstop supported by a pair of arms extending from the lower end of the chute forming a gap between the lower end and the backstop, wherein a package hitting the backstop is deflected through the gap into the selected one of the destination receptacles.

3. The multi-destination discharge chute of claim 1 comprising a pop-up backstop and actuator between adjacent destination receptacles, wherein the actuator raises the selected destination receptacle's backstop that is farther from the lower end above the level of the tops of the plurality of destination receptacles to block assigned packages from overshooting the selected destination receptacle and deflecting the assigned packages into the selected destination receptacle and wherein the actuator otherwise lowers the pop-up backstop below the level of the tops of the plurality of receptacles to avoid interfering with the chute while the receptacle mover is moving the plurality of destination receptacles.

4. The multi-destination discharge chute of claim 1 wherein the receptacle mover includes rails along which the receptacle mover moves the plurality of destination receptacles back and forth.

5. The multi-destination discharge chute of claim 1 wherein the receptacle mover includes rack-and-pinion system moving the plurality of destination receptacles back and forth.

6. The multi-destination discharge chute of claim 1 wherein the receptacle mover includes cable-and-pulley system moving the plurality of destination receptacles back and forth.

7. The multi-destination discharge chute of claim 1 wherein the receptacle mover includes a robotic vehicle moving the plurality of destination receptacles back and forth.

8. The multi-destination discharge chute of claim 1 wherein the receptacle mover includes a bidirectional belt moving the plurality of destination receptacles back and forth.

9. The multi-destination discharge chute of claim 8 wherein the receptacle mover includes a frame attached to the bidirectional belt and wherein the destination receptacles are open bags supported by the frame.

10. The multi-destination discharge chute of claim 1 comprising a package detector positioned to detect packages entering the destination receptacles.

11. The multi-destination discharge chute of claim 10 wherein the package detector comprises an array of photo eyes or a camera.

12. A sorting conveyor system comprising:
a main sorting conveyor transporting packages in a main conveying direction;
a controller controlling the main sorting conveyor to selectively sort the packages off one or both sides of the main sorting conveyor at sorting positions along its length;
one or more discharge sorting conveyors disposed at one or more sorting positions to receive packages sorted off the main sorting conveyor;
wherein the controller controls the one or more discharge sorting conveyors to selectively sort the packages off one or both sides of the discharge sorting conveyors at discharge sorting positions;
destination receptacles disposed at the discharge sorting positions to receive packages sorted off the one or more discharge sorting conveyors.

13. The sorting conveyor system of claim 12 comprising:
chutes immediately preceding the destination receptacles;
a multi-destination chute discharge system associated with at least some of the chutes;
two or more destination receptacles associated with the chutes associated with multi-destination chute discharge systems;
wherein the multi-destination chute discharge system directs each package on the chute to a selected one of the destination receptacles.

14. The sorting conveyor system of claim 13 wherein the multi-destination chute discharge system includes a flip gate at the end of the associated chute that pivots between a first position directing packages into a first destination receptacle and a second position directing packages into a second destination receptacle.

15. The sorting conveyor system of claim 14 wherein the flip gate includes a roller curtain having a first side and an opposite second side and wherein, when the flip gate is in the first position, packages ride on the first side of the roller curtain and wherein, when the flip gate is in the second position, packages ride on the second side of the roller curtain.

16. The sorting conveyor system of claim 13 wherein the multi-destination chute discharge system includes a pair of linear actuators along opposite sides of the chute, a pair of legs extending from the lower end of the chute, a motorized spindle supported by the legs, an inline roller belt attached at one end to the motorized spindle and at an opposite end to the pair of linear actuators, wherein the motorized spindle in activated to coil the inline roller belt about the spindle into a first position forming a gap between the inline roller belt coiled on the motorized spindle and the lower end of the chute through which packages drop into a first destination receptacle and wherein the motorized spindle is deactivated so that the pair of linear actuators draw the inline roller belt to the lower end of the chute in a second position closing the gap so that packages ride down the inline roller belt and drop into a second destination receptacle.

17. The sorting conveyor system of claim 13 wherein the multi-destination chute discharge system includes a receptacle mover moving the plurality of destination receptacles to position a selected one of the destination receptacles into position to receive packages assigned to it

18. The sorting conveyor system of claim 13 wherein the two or more destination receptacles have wheels and wherein the multi-destination chute discharge system includes a rail system including rails on which the receptacle wheels ride between a first position in which a first destination receptacle is positioned to receive a package from the chute and a second position in which a second destination receptacle is positioned to receive a package from the chute.

19. The sorting conveyor system of claim 13 wherein the multi-destination chute discharge system includes a conveyor belt atop which a first destination receptacle and a second destination receptacle sit, wherein the conveyor belt moves the receptacles from a first position in which the first destination receptacle is positioned to receive a package from the chute and a second position in which the second destination receptacle is positioned to receive a package from the chute.

20. The sorting conveyor system of claim 12 comprising a diverting conveyor abutting each of the one or more discharge sorting conveyors at the sorting positions to widen the landing zone of packages sorted off the main sorting conveyor and divert them onto the discharge sorting conveyor.

21. The sorting conveyor system of claim 12 comprising second destination receptacles disposed along one or both sides of the main sorting conveyor to receive packages sorted off the main sorting conveyor.

22. The sorting conveyor system of claim 12 wherein the controller assigns a destination receptacle to each package on the main sorting conveyor.

23. The sorting conveyor system of claim 22 comprising package detectors detecting packages entering each of the destination receptacles and reporting to the controller the entry of packages into the destination receptacles, wherein the controller determines if a package has been sorted to the assigned destination receptacle and, if not, notifies an operator of a missorted package.
